(19) United States
(12) Patent Application Publication
(10) Pub. No.: US 2013/0001355 A1
(43) Pub. Date: Jan. 3, 2013

(54) METHOD OF REDUCING FUEL CARRIED BY AN AIRCRAFT IN FLIGHT

(75) Inventors: Isaiah W. Cox, Baltimore, MD (US); Joseph Cox, Portland, OR (US)

(73) Assignee: Borealis Technical Limited, London (GB)

(21) Appl. No.: 13/410,120

(22) Filed: Mar. 1, 2012

Related U.S. Application Data
(60) Provisional application No. 61/448,187, filed on Mar. 1, 2011.

(51) Int. Cl. B64C 25/36

(52) U.S. Cl. 244/50

(57) ABSTRACT

A method for reducing the amount of fuel required to be carried in flight by an aircraft is provided that substantially reduces the taxi margin amount of fuel required by an aircraft, thereby reducing the aircraft's weight and producing significant increases in fuel use efficiency and savings in fuel costs. The substantially reduced taxi margin amount of fuel is produced by equipping an aircraft with at least one drive wheel powered by at least one onboard drive means that cooperatively drive the aircraft on the ground during taxi between takeoff and landing without reliance on the operation of the aircraft main engines.

### PRIORITY CLAIM

This application claims priority from U.S. Provisional Patent Application No. 61/448,187, filed Mar. 1, 2011.

### TECHNICAL FIELD

The present invention relates generally to methods for reducing the amount of fuel carried by an aircraft in flight and, specifically, to a method for reducing the amount of fuel required to be carried by an aircraft during flight by reducing fuel required for taxiing between takeoff and landing.

### BACKGROUND OF THE INVENTION

Airline operators today are faced with a plethora of challenges that affect operating costs. Not the least of these is the minimum amount of fuel their aircraft are required to carry by flight plans plus the excess fuel above the minimum needed to compensate for taxi requirements and potential taxi delays for each flight. Rising fuel costs can significantly impact operating expenses. Consequently, airline operators constantly examine ways to reduce fuel costs and, hence, overall operating costs. Environmental and other concerns, including compliance with aircraft engine CO₂ and greenhouse gas emissions standards and satisfying increased passenger demand for low cost air travel, also provide an impetus for reducing fuel costs. The amount of fuel burned by an aircraft during a flight depends on many factors that range from the age and type of aircraft to the specific flight plan approved by air traffic control and any excess fuel required to be carried, such as for taxi and/or potential taxi delays. Airline operators, therefore, may not always be in control of the amount of fuel that of their aircraft burns and the resulting cost of that fuel.

A flight plan describing an aircraft's proposed flight route between airports must include sufficient fuel to ensure that the aircraft can safely reach its destination. Flight planners try to minimize flight costs by their choice of the flight route, height, and speed and also by loading the minimum amount of fuel required to reduce the aircraft's weight and, thus, the amount of fuel burned. Safety regulations require aircraft to carry fuel beyond the minimum required to travel from the origin of the flight to the aircraft's destination. The amount of fuel carried must include fuel beyond the minimum to allow for unforeseen circumstances, such as, for example, adverse weather conditions or for diversion to another airport in the event the destination airport is not available. Delays in landing at the destination airport often require an aircraft to circle in a holding pattern before it can be cleared for landing. Delays in takeoff or taxi to an arrival point can require increased taxi time. Both of these situations use extra fuel and increase airline operating costs.

For a domestic flight within the United States conducted under Instrument Flight Rules, an aircraft is required to carry enough fuel to fly to the first point of intended landing, enough fuel to fly to an alternate airport if weather conditions require an alternate airport, and enough fuel for an additional 45 minutes at normal cruising speed. Moreover, additional fuel reserves are required based on the length of the flight or the amount fuel carried. A percentage of the flight time, typically 10%, and/or a percentage of fuel, typically 5%, may be used to calculate these fuel reserve amounts. For example, an 8 hour flight would need enough reserve fuel to fly for another 48 minutes, and a flight requiring 10,000 kg of fuel would require a fuel reserve of 500 kg. International flights have similar corresponding fuel and reserve requirements.

The flight plan on which the aircraft fuel requirements are based must not only take into account all of the aforementioned factors, but must also consider such factors as the weights associated with the aircraft and/or the total weight of the aircraft at various stages before take off, the route and altitude the aircraft must travel, the speed of the aircraft, and the wind speed. The fuel consumption rate of a particular aircraft and physical constraints that may affect aircraft weight may additionally require consideration in calculating minimum fuel requirements.

The high cost of fuel may be the prime motivation for airline operators to explore all available avenues to reduce the amount of fuel required for each of their aircraft's flight plans. The easiest way to reduce an aircraft's fuel consumption is to reduce the aircraft's weight. Over an equal flying distance, a lighter aircraft will burn less fuel. While methods of reducing both the weight of an aircraft and the equipment it carries are known, limiting passenger baggage, removing chipped paint and reducing the amount of drinking water carried can only go so far toward achieving reduced fuel consumption. It is estimated that airlines burn thousands of tons of fuel annually as their aircraft use the aircraft main engines to taxi between terminals and runways. The time an aircraft spends taxiing from the runway to the terminal upon landing and then from the terminal to the runway prior to takeoff can be 15 minutes or more in each direction, depending, in part, on the time of day and the number of arriving and departing flights the airport serves. When an aircraft is delayed for any reason and must sit on the ground with its engines idling or running, the aircraft is consuming fuel that must be planned for and accounted for in determining fuel requirements.

Suggestions for reducing aircraft fuel consumption during aircraft ground movement and ground operations have been made in the art. Deceleration upon landing, for example, using a combination of aerodynamic spoilers, thrust reversers, and brakes has been used, but this is not as efficient as could be desired because fuel must be burned to preserve engine thrust. The use of idle reverse thrust as opposed to maximum reverse thrust after landing can reduce fuel. This procedure still requires the operation of aircraft turbines, which adds to fuel consumption. Aircraft continue to rely on the operation of at least one fuel consuming turbine during taxi, however. Eliminating entirely the use of aircraft turbines to drive an aircraft between takeoff and landing could achieve substantial fuel savings and significantly reduce the amount of fuel an aircraft is required to carry by its flight plan and taxi requirements.

Moving an aircraft on the ground during taxi by means other than the main engines or turbines has been described in the art. In U.S. Pat. No. 7,445,178, McCoskey et al, for example, describe the use of a powered aircraft nose wheel system to move a taxiing aircraft from a terminal gate to a place where the main engines can be powered up for takeoff or to a place where the main engines can be shutdown after landing. While McCoskey et al suggest that their system reduces ground operational fuel costs, there is no mention whatever of any effect this may or may not have on aircraft minimum fuel required for flight or on excess fuel required for taxi or potential taxi delays.

Published U.S. Patent Application No US/2009/0261197 to Cox et al, owned in common with the present application, describes a nose wheel control apparatus capable of driving a taxiing aircraft without the use of the aircraft main engines. Using this apparatus to affect the amount of fuel an aircraft's flight plan dictates must be carried or fuel for taxi or fuel to compensate for potential taxi delays is not suggested, however.

The prior art, therefore, fails to appreciate the effect reducing potential taxi delays can have on reducing aircraft fuel requirements and, thus, aircraft flying weight and fuel costs. A method for reducing the extra amount of fuel carried by an aircraft in flight above the required minimum based on controlling aircraft ground movement to reduce the amount of fuel needed for taxi or to compensate for potential taxi delays has not been suggested.

### SUMMARY OF THE INVENTION

It is a primary object of the present invention, therefore, to provide a method for reducing the extra amount of fuel required to be carried by an aircraft in flight that is premised on reducing the amount of fuel needed for taxi and to compensate for potential taxi delays.

It is another object of the present invention to provide a method for reducing the extra fuel required to be carried by an aircraft in flight that includes driving a taxiing aircraft with one or more drive wheels driven by an onboard drive means powered by an alternative power source other than an aircraft main engine or turbine.

It is a further object of the present invention to provide a method for minimizing the amount of extra fuel required to be carried by an aircraft in flight.

It is an additional object of the present invention to provide a method for reducing an aircraft's required taxi margin amount of fuel that relies on an electric onboard drive means to move the aircraft on the ground during taxi.

It is yet another object of the present invention to provide a method for reducing an aircraft's fuel requirements for taxi or potential taxi delays.

It is yet a further object of the present invention to reduce the flying weight of an aircraft.

It is yet an additional object of the present invention to provide a method for reducing the amount of fuel carried by an aircraft in flight that does not compromise flight safety.

In accordance with the aforesaid objects, the present invention provides a method for reducing the amount of fuel in excess of the minimum required to be carried by an aircraft in flight that includes driving the aircraft on the ground between takeoff and landing without relying on the aircraft's main engines or turbines. The present method significantly reduces the quantity of fuel beyond that required by an aircraft's flight plan referred to as the taxi margin by employing one or more aircraft drive wheels, preferably powered by one or more onboard drive means, to drive the aircraft independently on the ground during taxi at departure prior to takeoff and upon landing. This method reduces the amount of taxi margin fuel and fuel to compensate for potential taxi delays required for takeoff and ensures that sufficient marginal fuel is available so that the aircraft will have no less than the minimum needed for the selected flight when the aircraft commences its takeoff roll.

Other objects and aspects of the method of reducing the extra fuel carried by an aircraft in flight of the present invention will become apparent from the following description, drawings, and claims.

### BRIEF DESCRIPTION OF THE SOLE DRAWING

FIG. 1 is a flow chart representing one approach to the method of the present invention during departure and take off of an aircraft equipped with onboard drive means.

### DESCRIPTION OF THE INVENTION

An aircraft's flight plan is designed to ensure that an aircraft has sufficient fuel to travel safely from its departure point to its destination. Flight planners may also be charged with minimizing flight cost, which, in addition to selecting an appropriate route, flying altitude, and flight speed, establishes a minimum amount of fuel that must be loaded on the aircraft for the journey. Since airline operators may not always be able to control the amount of fuel an aircraft burns, they are constantly looking for opportunities to minimize fuel consumption. The greater the minimum amount of fuel an aircraft is required to carry in flight, the more the aircraft weighs and the more fuel the aircraft consumes during flight. One way to reduce aircraft fuel consumption and, hence, fuel costs is to reduce the weight of the aircraft. Heretofore, reducing the total amount of fuel an aircraft is required to carry in flight was not possible without compromising flight safety. The present invention provides a way to reduce the amount of fuel an aircraft is required to carry during flight for taxi and to compensate for potential taxi delays and can reduce aircraft weight and fuel consumption without compromising flight safety.

An aircraft is required to load sufficient fuel to meet the flight plan minimum plus an amount of fuel to cover taxi time and potential taxi delays prior to be being cleared for takeoff. Extra fuel is required to enable the aircraft to continue to operate safely in the event of delays that may keep the aircraft in the air or on the ground longer than the flight plan or the estimated taxi time anticipates. Any extra fuel that an aircraft does not need is essentially dead weight and costly to fly around. Flying with too much extra fuel can add significantly to airline operating costs.

The amount of extra fuel beyond the minimum required for an aircraft's flight to a selected destination includes the amount required for the estimated taxi time and also to compensate for potential taxi delays prior to takeoff or upon landing. Much of this extra fuel, referred to as the taxi fuel margin, is budgeted for taxiing, but is not used. The vast majority of flights carry this extra taxi margin fuel. For each minute that the aircraft turbines are used to move a taxiing aircraft on the ground, over 10 pounds of fuel, and often over 20 pounds of fuel, must be included in the taxi margin fuel amount, which is above the minimum fuel required for the flight. Occasional taxi delays of 10 to 15 minutes, or more, each for takeoff and landing are not uncommon. Consequently, most aircraft today fly at a weight that is heavier than desired, which leads to higher fuel consumption and increases airline operating costs.

In the past, this meant that an aircraft would typically carry more extra fuel at takeoff than was needed, particularly in the event minimal or no taxi delays occurred so that the taxi margin fuel was not used, but carried by the aircraft as excess weight. The method of the present invention changes this situation by minimizing the taxi margin fuel requirement. Consequently, the amount of fuel beyond the minimum required to cover taxi time and potential taxi delays can be reduced substantially, with concomitant reductions in aircraft weight, fuel consumption, and fuel costs.

The present method of reducing the extra margin of fuel carried by an aircraft in flight is based on equipping the aircraft with at least one drive wheel that is powered by an onboard drive means capable of producing the torque required to drive a commercial aircraft on the ground at optimum taxi speed. The drive means is preferably powered by the aircraft auxiliary power unit (APU), but also may be powered by other aircraft power sources, such as, for example, generators on the aircraft engine, as well as any other suitable power source for this purpose. The powered drive wheel operates independently of the aircraft main engines to drive the aircraft on the ground during taxi between takeoff and landing. As a result, only the fuel required to power the aircraft APU, if the APU is the power source used, which is about 3 to 4 pounds per minute, is required to drive the aircraft during taxi.

The significant fuel and, therefore weight, reduction produced by the present invention can be illustrated as follows. For example, if an aircraft with a drive wheel powered by an onboard drive means in accordance with the present method takes off with extra fuel representing a taxi margin of 10 minutes, the aircraft is 40 pounds heavier. If an aircraft that does not have this type of powered drive wheel, but is dependent on the aircraft main engines to move it during taxi, takes off with extra fuel representing a taxi margin of 10 minutes, the aircraft is 100 to 200 pounds heavier. The heavier an aircraft is, the more fuel it consumes and the higher the operating cost. The fuel reduction and cost savings resulting from driving a taxiing aircraft on the ground with a powered drive wheel, as described herein, instead of the aircraft main engines are clearly significant.

The powered drive wheel employed by the present method may be any of the aircraft wheels that can be modified to be driven as described. In addition, the aircraft can be driven by more than one powered drive wheel. While the aircraft nose wheels may be a preferred powered drive wheel location, at least one powered drive wheel may also be positioned at other aircraft wheel locations.

An onboard electric driver is preferred for powering a drive wheel used in connection with the method of the present invention and will be mounted in driving relationship with an aircraft drive wheel to move the drive wheel at a desired speed and torque to drive the aircraft independently of external vehicles or the aircraft turbines during taxi. A driver particularly preferred for this purpose is a high phase order electric motor of the type described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. Other motor designs, such as, for example, hydraulic motors and pneumatic motors, that are capable of high torque operation across the speed range that can be integrated into or associated with an aircraft drive wheel to function as described herein may also be suitable for use in the method of reducing taxi margin fuel carried by an aircraft in accordance with the present invention.

It is contemplated that existing aircraft could be retrofitted with a drive wheel powered by an onboard driver that is powered by the aircraft APU or another aircraft or other power source other than an aircraft main engine or turbine as described herein. Consequently, an aircraft retrofitted with this type of powered drive wheel can realize significant fuel savings during taxi, thereby permitting the retrofitted aircraft to carry a reduced taxi margin fuel load compared to the taxi margin fuel load that required prior to installation of the powered drive wheel.

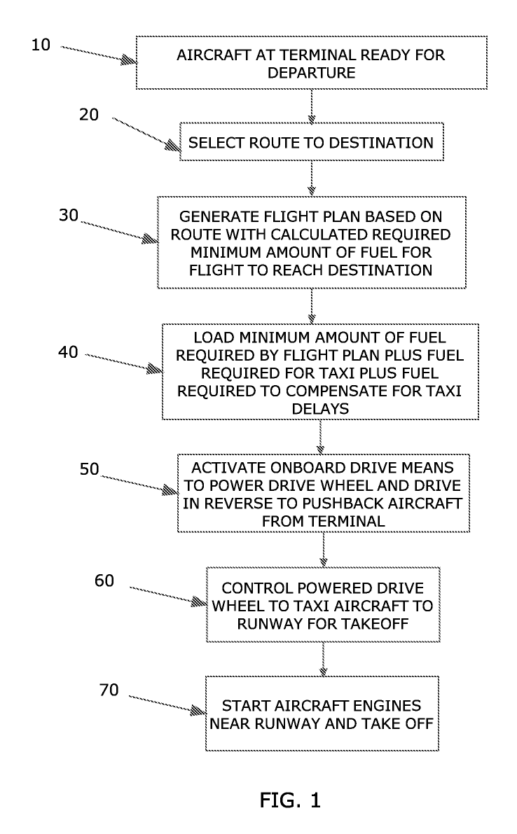

One approach to the method of the present invention that leads to fuel and cost savings by reducing the amount of extra taxi margin fuel carried by an aircraft in flight can be illustrated with reference to FIG. 1. As indicated in step 10, an aircraft is at the terminal ready for departure. The route to be traveled to the aircraft's destination is selected in step 20, and a flight plan with the calculated required minimum amount of fuel for the trip is generated in step 30. An extra amount of fuel to compensate for potential taxi delays is added to the minimum amount of fuel. The required minimum amount of fuel plus the extra taxi margin fuel amount is loaded in the aircraft at step 40. The aircraft may already contain fuel. In that event, the amount of fuel already loaded is subtracted from the minimum amount of fuel required for the trip plus the taxi margin amount to obtain the additional amount needed to insure that the aircraft is loaded with the correct amount of fuel as described above. The onboard drive means that powers the aircraft drive wheel is activated and powered by the aircraft APU or other power source to drive the aircraft in reverse and push back from the terminal in step 50. The driver is controlled to turn the aircraft as required and taxi the aircraft to a takeoff location on a runway, as indicated in step 70. The aircraft engines are started at this point and powered up for takeoff. The aircraft takes off, follows the selected flight route, arrives at the destination, and lands.

After landing, the aircraft engines are turned off as soon as possible. The onboard drive means is activated to power the drive wheel to drive the aircraft to taxi from the landing runway to arrival at the terminal. This method of driving a taxiing aircraft on the ground between takeoff and landing without the use of the aircraft's engines results in a substantial reduction of the minimum fuel required to be carried by the aircraft in flight. The accompanying savings in fuel costs and flight costs achieved by driving a taxiing aircraft with an onboard drive means powered drive wheel on the ground between takeoff and landing provide airline operators with more control over fuel consumption than has heretofore been possible. It is no longer necessary for aircraft to carry the thousands of tons of fuel required simply for taxiing between terminals and runways.

While the present invention has been described with respect to preferred embodiments, this is not intended to be limiting, and other arrangements and structures that perform the required functions are contemplated to be within the scope of the present invention.

### INDUSTRIAL APPLICABILITY

The method for reducing the minimum amount of fuel and the taxi margin amount of fuel required to be carried by an aircraft in flight by equipping an aircraft with an onboard drive means to power a drive wheel to drive a taxiing aircraft without the aircraft main engines described herein will find its primary applicability wherever airline operators wish to reduce aircraft fuel consumption and, thus, lower fuel costs. The present method can also be effectively employed when it is desired to achieve the reduced CO₂ emissions that accompany the reduced fuel consumption possible with this method.

1. A method for reducing the average amount of fuel carried by an aircraft in flight by reducing the amount of fuel required for taxi margin.

2. The method for reducing the amount of fuel described in claim 1, wherein the amount of fuel required for taxi margin is reduced by driving a taxiing aircraft on the ground between takeoff and landing with at least one drive wheel mounted on the aircraft controllably powered by at least one onboard drive means that obtains power to drive the drive wheel from the aircraft auxiliary power source or another aircraft power source.

3. The method for reducing the minimum amount of fuel required described in claim 2, wherein the at least one drive wheel is powered by an onboard electric drive means.

4. The method for reducing the minimum amount of fuel required described in claim 3, wherein the electric drive means is an electric motor selected from the group consisting of electric induction motors, permanent magnet brushless DC motors, and switched reluctance motors.

5. The method for reducing the minimum amount of fuel required described in claim 2, wherein the onboard drive means is a hydraulic motor or a pneumatic motor.

6. The method for reducing the minimum amount of fuel required described in claim 2, wherein said at least one drive wheel is one of the aircraft nose wheels or one of the aircraft main wheels.

7. The method for reducing the minimum amount of fuel required described in claim 2, wherein said at least one drive wheel comprises two nose wheels and each of said nose wheels is powered by an onboard drive means.

8. A method for minimizing the extra fuel required for taxi and potential taxi delays beyond the calculated minimum amount of fuel required to be carried by an aircraft for travel to a selected destination by operating at least one onboard drive means not powered by the aircraft main engines mounted to drive an aircraft drive wheel to move the aircraft on the ground during taxi, thereby reducing the amount of fuel required for taxi, further reducing the weight of the aircraft and increasing the efficiency of fuel consumption by the aircraft in flight to the selected destination.

9. A method for reducing airline fuel requirements and fuel costs by reducing the amount of fuel carried in flight by each aircraft operated by the airline, wherein the method comprises equipping each said aircraft with at least one drive wheel controllably powered by an onboard drive means powered by a power source other than the aircraft main engines to drive each said aircraft independently on the ground during taxi between takeoff and landing so that the taxi margin fuel required is substantially less than the taxi margin amount of fuel for an aircraft driven during taxi by the aircraft main engines, thereby requiring a lower amount of fuel for flight for each said aircraft driven by a drive wheel during taxi and a lower amount of fuel and reducing airline fuel requirements and fuel costs.

10. A method for reducing the amount of fuel carried in flight by an aircraft equipped with at least one drive wheel powered by an onboard drive means powered by a source other than an aircraft main engine to drive the aircraft on the ground during taxi between takeoff and landing to reduce the taxi margin amount of fuel, wherein the total amount of fuel required for flight is calculated based on the reduced taxi margin amount to require sufficient fuel for the aircraft to reach its destination without compromising flight safety.
